(19) United States
(12) Patent Application Publication
(10) Pub. No.: US 2026/0121330 A1
(43) Pub. Date: Apr. 30, 2026

(54) Connector Assembly and Related Methods

(71) Applicant: Aptiv Technologies AG, Schaffhausen (CH)

(72) Inventors: Bhuvaneshwaran Gunaseelan, Chennai (IN); Venkatesan Mahalingam, Gudiyatham taluk (IN); Vignesh Murali, Chennai (IN); John D. Schneider, Warren, OH (US)

(21) Appl. No.: 18/925,320

(22) Filed: Oct. 24, 2024

(51) Int. Cl. H01R 13/424; H01R 43/20

(52) U.S. Cl. CPC H01R 13/424; H01R 43/20; H01R 2201/26

(57) ABSTRACT

A terminal lock member is configured to move between a first position and a second position within a connector. The terminal lock member includes a locking arm portion and a ramp portion. The locking arm portion is configured to secure the terminal lock member in the first position. The ramp portion extends from the locking arm portion and is configured to engage a terminal. The terminal lock member is configured to move from the first position to the second position upon engaging the terminal.

### FIELD

The present disclosure relates to a terminal lock member and more particularly to a connector assembly including a terminal lock member that may be used in connection with vehicles.

### BACKGROUND

Modern vehicles (e.g., automobiles) rely on electrical wiring and electrical connections to facilitate communication between various electronic components within the vehicle. Connection systems (e.g., connectors and terminals) play an important role in ensuring the integrity of these electrical connections and the reliability and performance of the vehicle. Conventional connection systems typically include a housing and one or more terminals designed to make contact and establish electrical pathways with terminals located in a mating connector housing.

Ensuring the secure engagement and retention of terminals within the connector housing, and the secure engagement and retention between components (e.g., seals, terminal and connector position assurance pieces, etc.) within and/or between the connector housings, is crucial for maintaining a reliable electrical connection. Some connection systems utilize mechanisms such as locking clips, levers, or additional components designed to engage terminals and/or components within the connector housing. While providing increased retention, these solutions often add complexity, cost, and assembly challenges to the connector design.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides a terminal lock member configured to move between a first position and a second position within a connector. The terminal lock member includes a locking arm portion and a ramp portion. The locking arm portion is configured to secure the terminal lock member in the first position. The ramp portion extends from the locking arm portion and is configured to engage a terminal. The terminal lock member is configured to move from the first position to the second position upon engaging the terminal.

Another aspect of the disclosure provides a method. The method includes inserting a terminal lock member into a cavity of a connector. The method includes inserting a terminal into the cavity. Inserting the terminal into the cavity includes engaging the terminal with a ramp portion of the terminal lock member and causing, by sliding the terminal along the ramp portion, the terminal lock member to move from a first position to a second position. The method includes securing the terminal to the connector.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is an exploded view of an example connector assembly in accordance with the principles of the present disclosure.

FIG. 2 is a bottom view of the connector assembly of FIG. 1 in an assembled configuration in accordance with the principles of the present disclosure.

FIG. 3 is a perspective view of an example connector body of a connector assembly in accordance with the principles of the present disclosure.

FIGS. 4 and 5 are perspective views of an example inner housing of a connector assembly in accordance with the principles of the present disclosure.

FIG. 6 is a perspective view of an example terminal lock member of a connector assembly in accordance with the principles of the present disclosure.

FIG. 7 is a front view of the terminal lock member of FIG. 6.

FIG. 8 is a side view of the terminal lock member of FIG. 6.

FIG. 9 is a cross-sectional view of the connector assembly of FIG. 1 taken along the line 9-9 of FIG. 2 in a first stage of assembly in accordance with the principles of the present disclosure.

FIG. 10 is a cross-sectional view of the connector assembly of FIG. 1 taken along the line 9-9 of FIG. 2 in a second stage of assembly in accordance with the principles of the present disclosure.

FIG. 11 is a perspective view of the inner housing of FIG. 4 and the terminal lock member of FIG. 6 in a secured configuration in accordance with the principles of the present disclosure.

FIG. 12 is a flowchart depicting an example method for assembling a connector assembly in accordance with the principles of the present disclosure.

In the drawings, reference numbers may be reused to identify similar and/or identical elements.

### DETAILED DESCRIPTION

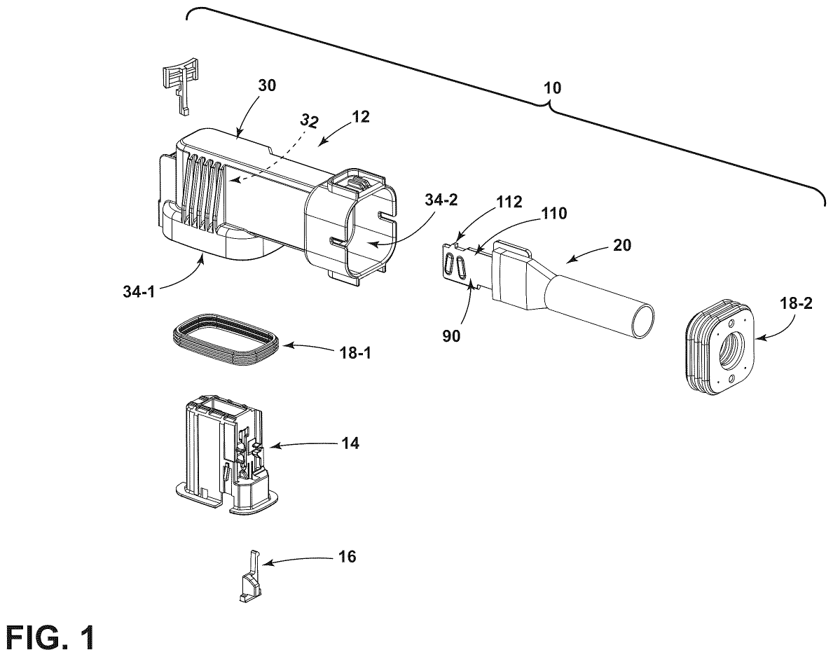

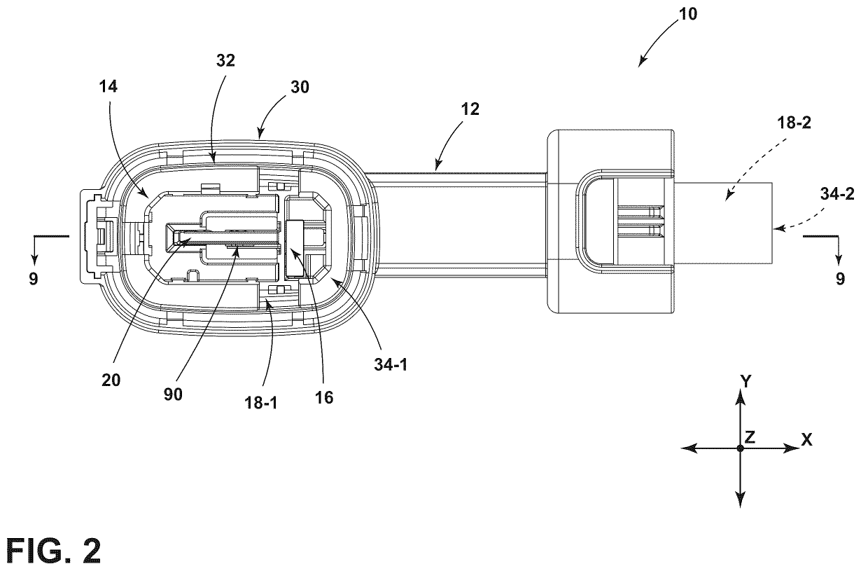

With reference to FIGS. 1 and 2, an example connector assembly 10 is shown. As will be explained in more detail below, the connector assembly 10 may be installed in a vehicle (e.g., an automobile) to facilitate the transmission of electricity between various electronic components within the vehicle. For example, the connector assembly 10 may be a female connector detachably coupled to a mating connector (e.g., a male connector, not shown) such that, during operation, of the vehicle, electricity is transmitted between the connector assemblies and to various electronic components within the vehicle.

In various implementations, the connector assembly 10 includes a connector body 12, an inner housing 14, a terminal lock member 16, a first seal 18-1, a second seal 18-2, and/or a set of terminal assemblies 20, among others. The connector body 12 may include a plurality of walls 30 that define a cavity 32, a first opening 34-1, and a second opening 34-2. The cavity 32 may be in communication with the first opening 34-1 and the second opening 34-2. In various implementations, the inner housing 14, the terminal lock member 16, and at least portions (e.g., terminals) of the set of terminal assemblies 20 are removably-disposed in the cavity 32. The first seal 18-1 may be removably-disposed in the first opening 34-1 and the second seal 18-2 may be removably-disposed in the second opening 34-2.

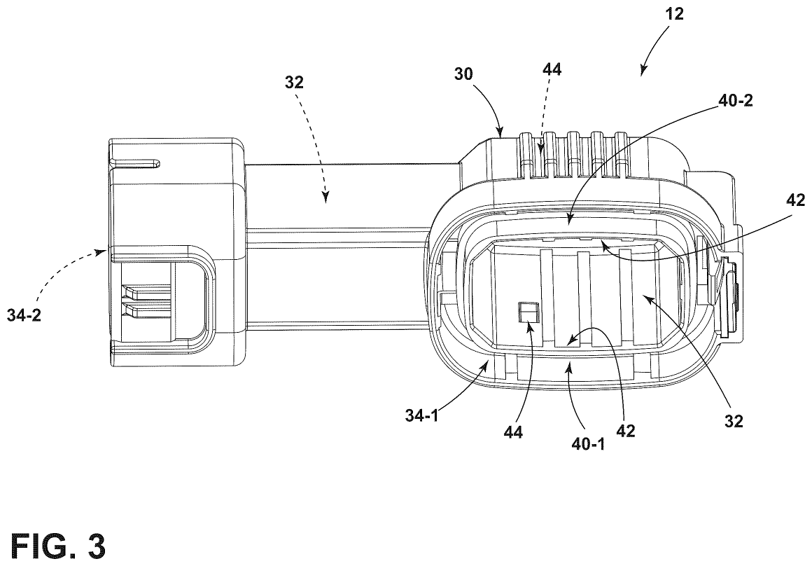

With reference to FIG. 3, an example connector body 12 is shown. The connector body 12 may comprise one or more of a variety of shapes, sizes, configurations, and/or materials. In various implementations, the connector body 12 includes a first sidewall 40-1 and a second sidewall 40-2 opposite the first sidewall 40-1. The first and second sidewalls 40-1, 40-2 may each define a set of channels 42 and a void 44, among others. The channels 42 and the void 44 may receive portions of the inner housing 14 to align the inner housing 14 in the cavity 32 and to removably connect the inner housing 14 to the connector body 12. In various implementations, the connector body 12 and the inner housing 14 collectively define a connector.

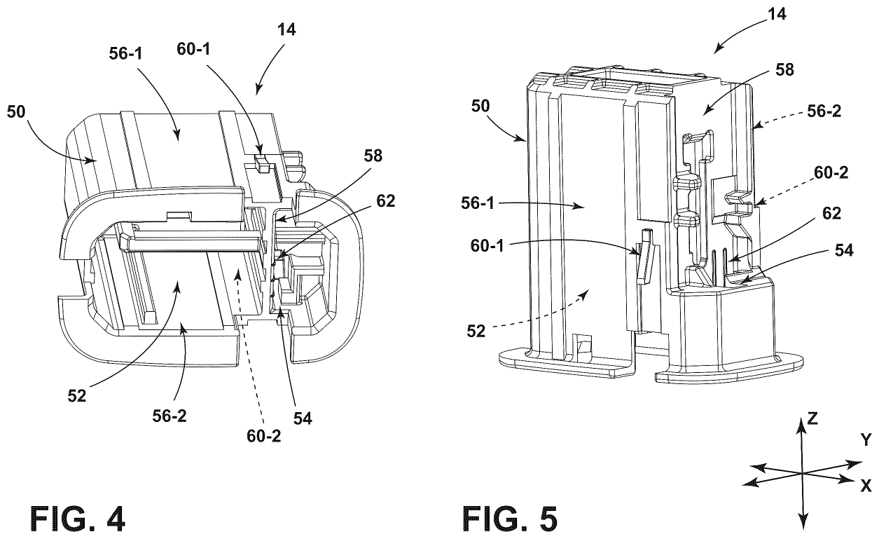

With reference to FIGS. 4 and 5, an example inner housing 14 is shown. The inner housing 14 may comprise one or more of a variety of shapes, sizes, configurations, and/or materials. In various implementations, the inner housing 14 includes a plurality of walls 50 that define a first cavity 52 and a second cavity 54 in communication with the first cavity 52. The first cavity 52 may receive the mating connector and/or a portion (e.g., a terminal) of a terminal assembly 20. The second cavity 54 may receive the terminal lock member 16 and a portion (e.g., s terminal) of a terminal assembly 20.

In various implementations, the inner housing 14 includes a first sidewall 56-1, a second sidewall 56-2 opposite the first sidewall 56-1, and an end wall 58 that extends between the first and second sidewalls 56-1, 56-2. In various implementations, the inner housing 14 includes a first locking arm 60-1 that extends from the first sidewall 56-2, and a second locking arm 60-2 that extends from the second sidewall 56-2. The first and second locking arms 60-1, 60-2 may be received by the voids 44 of the connector body 12. In various implementations, the first and second locking arms 60-1, 60-2 are flexible and may allow the insertion of, and/or inhibit the removal of, the inner housing 14 from the cavity 32 of the connector body 12.

In various implementations, the inner housing 14 includes a plurality of ribs 62 that extend from and along (e.g., in the Z-direction) the end wall 58. As will be explained in more detail below, the terminal lock member 16 may move relative to the inner housing 14 in the second cavity 54. The terminal lock member 16 may engage the ribs 62 when the terminal lock member 16 moves in the second cavity 54. The ribs 62 comprise less surface area in comparison with the end wall 58 such that movement (e.g., sliding) of the terminal lock member 16 within the second cavity 54 and along the ribs 62 produces a smaller frictional force on the terminal lock member 16 than would be produced by the end wall 58. The foregoing allows the terminal lock member 16 to move more freely in the second cavity 54.

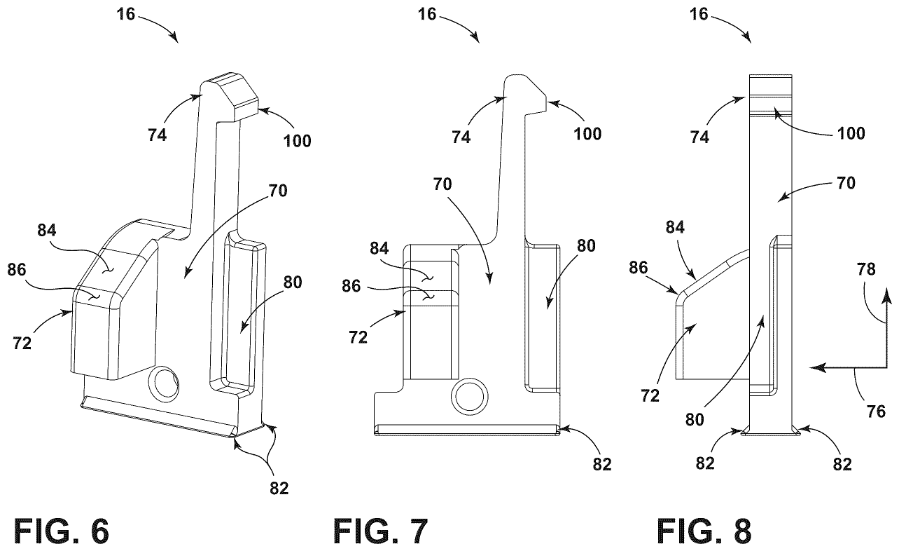

With reference to FIGS. 6-8, an example terminal lock member 16 (i.e., an independent secondary lock (ISL)) is shown. The terminal lock member 16 may comprise one or more of a variety of shapes, sizes, configurations, and/or materials. In various implementations, the terminal lock member 16 may include a body 70, a ramp portion 72, and a locking arm portion 74, among others. The terminal lock member 16 may be integrally formed. For example, the body 70, the ramp portion 72, and the locking arm portion 74 may be formed as a monolithic construct from an injection molding process, for example.

In various implementations, the ramp portion 72 and the locking arm portion 74 extend from the body 70. In some example configurations, the ramp portion 72 extends from the body 70 in a first direction 76 and the locking arm portion 74 extends from the body 70 in a second direction 78 transverse (e.g., orthogonal) to the first direction 76 (see, e.g., FIG. 8).

In various implementations, the body 70 includes a cutout 80 and an outwardly-extending flange 82, among others. The cutout 80 may be received by a portion of the inner housing 14 to align the terminal lock member 16 to the inner housing 14 during assembly and/or to guide the movement of the terminal lock member 16 in the second cavity 54 of the inner housing 14. The cutout 80 may be offset from the ramp portion 72. In the assembled configuration, the flange 82 engages portions of the inner housing 14 to inhibit containments from entering the second cavity 54.

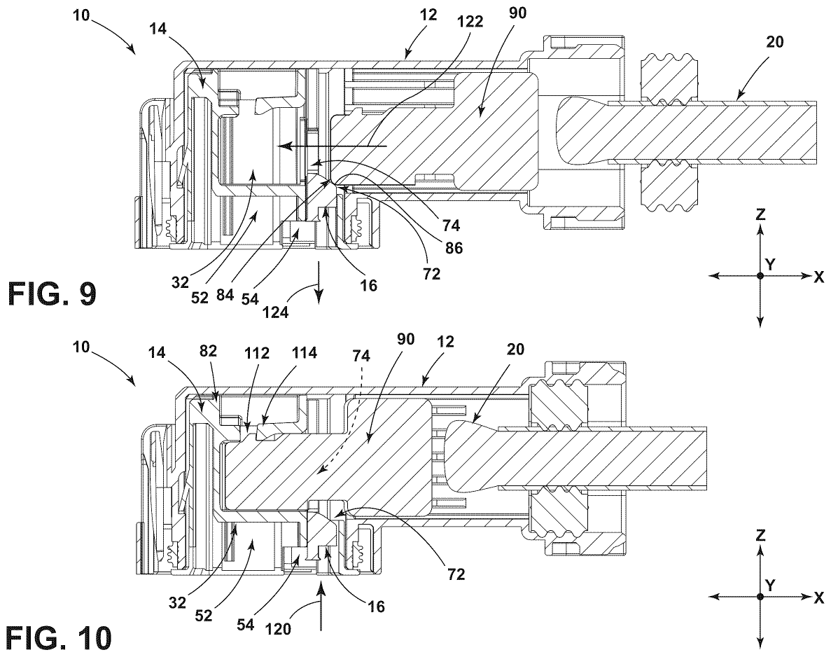

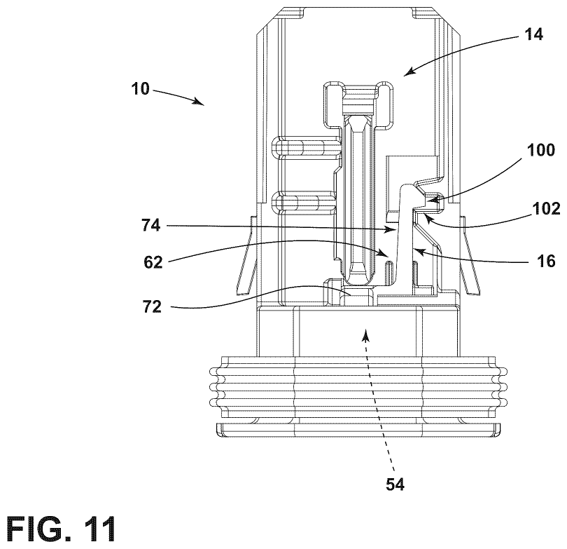

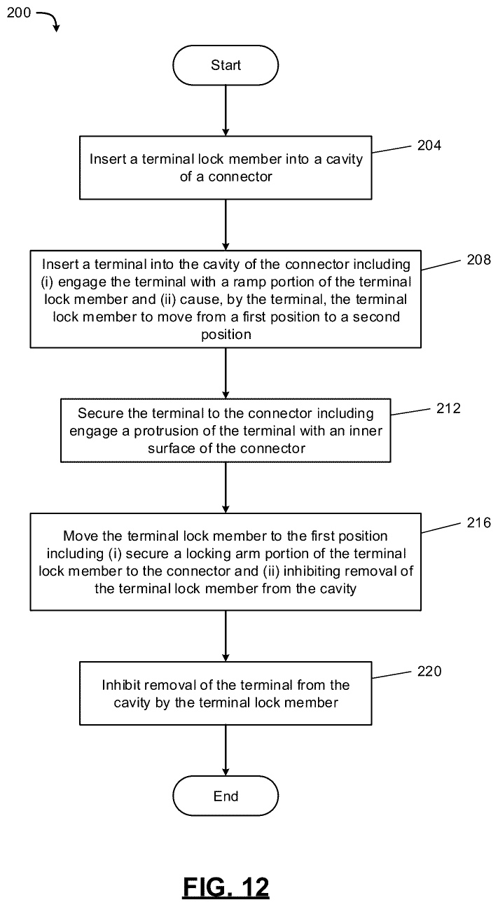

In various implementations, the ramp portion 72 includes a sloped surface 84 and a radiused surface 86, among others. As will be explained in more detail below, the sloped surface 84 and/or the radiused surface 86 may slidably-engage a terminal 90 of a terminal assembly 20 during assembly of the connector assembly 10. In particular, the terminal lock member 16 may move between a first position (e.g., a secured position) (see, e.g., FIGS. 9 and 11) and a second position (e.g., an unsecured position) (see, e.g., FIG. 10) in the second cavity 54 of the inner housing 14, for example, when the ramp portion 72 is engaged by the terminal 90. In various implementations, the terminal lock member 16 may be locked to the inner housing 14 when in the first position, and the terminal lock member 16 may be unlocked from the inner housing 14 when in the second position. In various implementations, the terminal lock member 16 moves from the first position to the second position during insertion of the terminal 90 into the second cavity 54.

In various implementations, the locking arm portion 74 may be flexible such that the locking arm portion 74 may allow the insertion of, and/or inhibit the removal of, the terminal lock member 16 from the second cavity 54, for example, during assembly of the connector assembly 10. In various implementations, the locking arm portion 74 may include an outwardly-extending tab 100 that engages an inner wall 102 of the inner housing 14 when the terminal lock member 16 is in the first position (see, e.g., FIG. 11). In various implementations, the locking arm portion 74 may be secured (e.g., locked) to the inner housing 14 when the terminal lock member 16 is in the first position and the locking arm portion 74 may be unsecured (e.g., unlocked) to the inner housing 14 when the terminal lock member is in the second position.

Referring again to FIG. 1, a terminal assembly 20 may comprise one or more of a variety of shapes, sizes, configurations, and/or materials. In various implementations, a terminal 90 of a terminal assembly 20 may include a body 110 and a protrusion 112 extending from the body 110. In various implementations, in the assembled configuration, the protrusion 112 may engage an inner surface 114 of the inner housing 14 such that the terminal 90 is inhibited from moving out of the cavity 32 (see, e.g., FIG. 10).

With reference to FIG. 2, the connector assembly 10 is shown in an assembled configuration. In the assembled configuration, the inner housing 14, the terminal lock member 16, and a terminal 90 of a terminal assembly 20 are disposed in the cavity 32 of the connector body 12. In various implementations, the terminal lock member 16 is in the first position, for example, the locking arm portion 74 of the terminal lock member 16 is secured to the inner housing 14 (see, e.g., FIG. 11). The locking arm portion 74 inhibits the terminal lock member 16 from moving out of the cavity 32 (e.g., in the Z-direction). In various implementations, the terminal lock member 16 inhibits the terminal 90 from moving out of the cavity 32 (e.g., in the X-direction).

FIG. 12 is a flowchart of an example method 200 for assembling a connector assembly 10. The method 200 may begin at 204. At 204, a user may insert a terminal lock member 16 into a cavity (e.g., the cavity 32 and/or the second cavity 54) of a connector. In various implementations, the terminal lock member 16 may be inserted into the cavity in a first direction 120 (e.g., parallel to the Z-direction) (see, e.g., FIG. 10). The method 200 may proceed to 208.

With reference to FIG. 9, at 208, a user may insert a terminal 90 of a terminal assembly 20 into the cavity. In various implementations, the terminal 90 may be inserted into the cavity in a second direction 122 (e.g., parallel to the X-direction) orthogonal to the first direction 120. In various implementations, inserting the terminal 90 into the cavity includes engaging the terminal 90 with the ramp portion 72 of the terminal lock member 16 and causing, by the terminal 90, the terminal lock member 16 to move from a first position (e.g., a secured position) to a second position (e.g., an unsecured position). In various implementations, the terminal 90 engages the ramp portion 72 in the second direction 122 (e.g., parallel to the X-direction). The terminal 90 causes the terminal lock member 16 to move in a third direction 124 (e.g., parallel to the Z-direction). The third direction 124 is opposite the first direction 120 and orthogonal to the second direction 122. The method 200 may proceed to 212.

With reference to FIG. 10, at 212, the terminal 90 may be secured to the connector. For example, securing the terminal 90 to the connector may include engaging a protrusion 112 of the terminal 90 with an inner surface 114 of the connector. The method 200 may proceed to 216.

At 216, a user may move the terminal lock member 16 to the first position (e.g., the secured position). In various implementations, moving the terminal lock member to the first position includes moving the terminal lock member 16 in the first direction 120 to secure the locking arm portion 74 of the terminal lock member 16 to the connector. The method 200 includes inhibiting removal of the terminal lock member 16 from the cavity (e.g., in the Z-direction) when the terminal lock member 16 is in the first position. The method 200 may proceed to 220.

At 220, the terminal lock member 16 may inhibit removal of the terminal 90 from the cavity (e.g., in the X-direction). Then the method 200 may end.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “set” does not necessarily exclude the empty set—in other words, in some circumstances a “set” may have zero elements. The term “non-empty set” may be used to indicate exclusion of the empty set—in other words, a non-empty set will always have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The following Clauses provide an exemplary configuration for a connector assembly and related methods, as described above.

Clause 1: A terminal lock member configured to move between a first position and a second position within a connector, the terminal lock member comprising: a locking arm portion configured to secure the terminal lock member in the first position; and a ramp portion extending from the locking arm portion and configured to engage a terminal, the terminal lock member configured to move from the first position to the second position upon engaging the terminal.

Clause 2: The terminal lock member of clause 1, wherein the ramp portion includes a radiused surface.

Clause 3: The terminal lock member of clause 1 or 2, wherein the ramp portion includes a sloped surface configured to slidably-engage the terminal.

Clause 4: The terminal lock member of any of clauses 1 through 3, wherein: the terminal lock member includes a body; and the locking arm portion and the ramp portion extend from the body.

Clause 5: The terminal lock member of clause 4, wherein: the ramp portion extends from the body in a first direction; and the locking arm portion extends from the body in a second direction transverse to the first direction.

Clause 6: The terminal lock member of any of clauses 1 through 5, wherein the terminal lock member includes a monolithic construct.

Clause 7: The terminal lock member of any of clauses 1 through 6, wherein the locking arm portion includes an outwardly-extending tab.

Clause 8: The terminal lock member of any of clauses 1 through 7, wherein: the terminal lock member includes a body; the body includes a cutout; and the cutout is offset from the ramp portion.

Clause 9: The terminal lock member of any of clauses 1 through 8, wherein: the terminal lock member includes a body; and the body includes an outwardly-extending flange.

Clause 10: A connector comprising the terminal lock member of any of clauses 1 through 9, wherein: the connector defines a cavity configured to receive the terminal; and the terminal lock member is configured to move from the first position to the second position during insertion of the terminal into the cavity.

Clause 11: The connector of clause 10, wherein: the connector includes a rib that extends along a wall of the connector; the terminal lock member engages the rib; and the rib is configured to reduce friction when the terminal lock member moves relative to the connector.

Clause 12: A method comprising: inserting a terminal lock member into a cavity of a connector; inserting a terminal into the cavity, including: engaging the terminal with a ramp portion of the terminal lock member; and causing, by sliding the terminal along the ramp portion, the terminal lock member to move from a first position to a second position; and securing the terminal to the connector.

Clause 13: The method of clause 12, wherein: the terminal lock member is inserted into the cavity in a first direction; and the terminal is inserted into the cavity in a second direction orthogonal to the first direction.

Clause 14: The method of clause 12 or 13, wherein: the terminal engages the ramp portion in a first direction; and the terminal causes the terminal lock member to move in a second direction orthogonal to the first direction.

Clause 15: The method of any of clauses 12 through 14, wherein: the terminal lock member is inserted into the cavity in a first direction; and causing the terminal lock member to move from the first position to the second position includes moving the terminal lock member in a second direction opposite the first direction.

Clause 16: The method of any of clauses 12 through 15, wherein a locking arm portion of the terminal lock member is secured to the connector when the terminal lock member is in the first position.

Clause 17: The method of clause 16, wherein the locking arm portion is unsecured from the connector when the terminal lock member is in the second position.

Clause 18: The method of any of clauses 12 through 17, further comprising: moving the terminal lock member to the first position; and securing a locking arm portion of the terminal lock member to the connector.

Clause 19: The method of clause 18, further comprising inhibiting removal of the terminal from the cavity by the terminal lock member.

Clause 20: The method of any of clauses 12 through 19, wherein securing the terminal to the connector includes engaging a protrusion of the terminal with an inner surface of the connector.

1. A terminal lock member configured to move between a first position and a second position within a connector, the terminal lock member comprising:
a locking arm portion configured to secure the terminal lock member in the first position; and
a ramp portion extending from the locking arm portion and configured to engage a terminal, the terminal lock member configured to move from the first position to the second position upon engaging the terminal.

2. The terminal lock member of claim 1 wherein the ramp portion includes a radiused surface.

3. The terminal lock member of claim 1 wherein the ramp portion includes a sloped surface configured to slidably-engage the terminal.

4. The terminal lock member of claim 1 wherein:
the terminal lock member includes a body; and
the locking arm portion and the ramp portion extend from the body.

5. The terminal lock member of claim 4 wherein:
the ramp portion extends from the body in a first direction; and
the locking arm portion extends from the body in a second direction transverse to the first direction.

6. The terminal lock member of claim 1 wherein the terminal lock member includes a monolithic construct.

7. The terminal lock member of claim 1 wherein the locking arm portion includes an outwardly-extending tab.

8. The terminal lock member of claim 1 wherein:
the terminal lock member includes a body;
the body includes a cutout; and
the cutout is offset from the ramp portion.

9. The terminal lock member of claim 1 wherein:
the terminal lock member includes a body; and
the body includes an outwardly-extending flange.

10. A connector comprising the terminal lock member of claim 1 wherein:
the connector defines a cavity configured to receive the terminal; and
the terminal lock member is configured to move from the first position to the second position during insertion of the terminal into the cavity.

11. The connector of claim 10 wherein:
the connector includes a rib that extends along a wall of the connector;
the terminal lock member engages the rib; and
the rib is configured to reduce friction when the terminal lock member moves relative to the connector.

12. A method comprising:
inserting a terminal lock member into a cavity of a connector;
inserting a terminal into the cavity, including:
engaging the terminal with a ramp portion of the terminal lock member; and
causing, by sliding the terminal along the ramp portion, the terminal lock member to move from a first position to a second position; and
securing the terminal to the connector.

13. The method of claim 12 wherein:
the terminal lock member is inserted into the cavity in a first direction; and
the terminal is inserted into the cavity in a second direction orthogonal to the first direction.

14. The method of claim 12 wherein:
the terminal engages the ramp portion in a first direction; and
the terminal causes the terminal lock member to move in a second direction orthogonal to the first direction.

15. The method of claim 12 wherein:
the terminal lock member is inserted into the cavity in a first direction; and
causing the terminal lock member to move from the first position to the second position includes moving the terminal lock member in a second direction opposite the first direction.

16. The method of claim 12 wherein a locking arm portion of the terminal lock member is secured to the connector when the terminal lock member is in the first position.

17. The method of claim 16 wherein the locking arm portion is unsecured from the connector when the terminal lock member is in the second position.

18. The method of claim 12 further comprising:
moving the terminal lock member to the first position; and
securing a locking arm portion of the terminal lock member to the connector.

19. The method of claim 18 further comprising inhibiting removal of the terminal from the cavity by the terminal lock member.

20. The method of claim 12 wherein securing the terminal to the connector includes engaging a protrusion of the terminal with an inner surface of the connector.
